(19) United States
(12) Patent Application Publication
(10) Pub. No.: US 2005/0019448 A1
(43) Pub. Date: Jan. 27, 2005

(54) Liquid flavoring dissolving strips and method of use thereof

(76) Inventor: Kevin Engelhardt, Omaha, NE (US)

Correspondence Address: Law Offices of Adam H. Jacobs;Adam H. Jacobs, Suite 726, 1904 Farnam Street, Omaha, NE, 68102, US

(21) Appl. No.: 10/894,762

(22) Filed: Jul. 20, 2004

Related U.S. Application Data
(60) Provisional application No. 60/489,334, filed on Jul. 22, 2003.

(51) Int. Cl. A23L 1/00

(52) U.S. Cl. 426/89

(57) ABSTRACT

A method of flavoring a liquid comprising the steps of providing a generally inert base material which is soluble in water and a flavoring material, preferably of the citrus genre. A generally inert base material such as pullulan is then impregnated with the flavoring material to form a solid mixture wherein the generally inert base material functions to carry the flavoring material which is then formed into at least two discrete solid dissolving units. These are stored in a dispensing container operative to permit dispensing of a selected one of units while retaining the remaining units therein. At least one of the solid dissolving units is then placed in a liquid medium at which time the generally inert base material dissolves via the liquid medium to release the flavoring material into the liquid medium thereby flavoring the liquid medium via the flavoring material.

### CROSS-REFERENCE TO RELATED PROVISIONAL PATENT

This application claims priority based on a provisional patent, specifically on the Provisional Patent Application Ser. No. 60/489,334 filed Jul. 22, 2003.

### BACKGROUND OF THE INVENTION

1. Technical Field

The present invention relates to liquid flavoring materials and methods and, more particularly, to a flavored dissolving strip having citrus flavors or the like impregnated therein which, when placed in an amount of liquid, will dissolve releasing the citrus flavors into the liquid and increasing the palatability of the liquid and a method of use thereof.

2. Description of the Prior Art

It is recommended by health experts and nutritionists that the average person drink upwards of eight glasses of water per day (8 oz. each) in order to ensure proper hydration and decrease susceptibility to infection and disease. However, the ingestion of such large quantities of water is not always an enjoyable experience, as water has little or no taste and therefore does not necessarily please the palate. It has thus become popular to add a citrus flavoring such as lemon, lime, or orange to the water being ingested via the insertion of a slice of the citrus fruit into the water. While the addition of the citrus flavoring increases the palatability of the water, it is not always possible to obtain fresh citrus to provide the flavoring for the water. Furthermore, the sectioning, slicing, and inserting of the citrus material can significantly increase the time spent in preparing a glass of water which decreases the enjoyment factor and thus makes it unlikely that a person having a single glass of water will go through the process of preparing a slice of citrus for insertion into the water. Also, it is not only water which is now being flavored, as people have taken to adding citrus flavorings to sodas, alcoholic drinks, and other such liquid ingestibles to increase the palatability and improve the taste of those liquids. There is therefore a need for an easy-to-use flavoring material and method for use thereof which will quickly and easily add citrus flavoring to liquids.

While at the present time there are numerous different types of additives and flavoring materials which can be added to water to produce a certain taste, the vast majority of these include some type of artificial or natural sweetener which is included with the flavoring material. The sweetener material acts as the binding agent for the flavoring material to bring the flavoring material into the water and, upon dissolving, sweetens and flavors the water. Examples of such water flavoring materials include Kool-Aid, Crystal Light, and Za-Rex, and each of these flavoring devices function in substantially the same manner. Without exception, however, these flavoring materials substantially change the taste of the water instead of merely adding a flavoring to the water, and furthermore as many of these flavoring materials include sweeteners, the resulting mixture does not confer the same fluid-replenishing benefits as ordinary water would confer.

A further problem encountered in the use of the majority of flavoring materials is that they are not generally convenient to use as they come in a powdered form which may be easily spilled outside of the container in which the mixture is to be prepared. Also, because the flavoring materials of the prior art are packaged for use with liquid volumes of specific amounts, it can be somewhat difficult to use the flavoring material with a liquid volume of a different amount, and it is virtually guaranteed that the resulting liquid mixture will not have exactly the intended taste of the liquid mixture as if the specific recommended volume of liquid were used. There is therefore a need for a liquid flavoring method which may be quickly and easily applied to many different volumes of liquid, comes in an easily-dispensable format, and which will not add sweetener to the resulting liquid mixture.

Therefore, an object of the present invention is to provide an improved liquid flavoring dissolving strip and method of use thereof.

Another object of the present invention is to provide an improved liquid flavoring dissolving strip and method of use thereof which includes a flavored dissolving strip having citrus flavors or the like impregnated therein which, when placed in an amount of liquid, will dissolve, thus releasing the citrus flavors into liquid.

Another object of the present invention is to provide an improved liquid flavoring dissolving strip and method of use thereof in which the dissolving strip is constructed of a material such as pullulan or the like which, when impregnated with a flavoring material such as a citrus flavoring, will dissolve within the liquid to release the flavoring material through the liquid.

Another object of the present invention is to provide an improved liquid flavoring dissolving strip and method of use thereof which is easily transportable and may be used in a variety of situations.

Another object of the present invention is to provide an improved liquid flavoring dissolving strip and method of use thereof which may be used with a variety of different liquids to provide instant citrus flavoring for the liquid.

Finally, an object of the present invention is to provide a liquid flavoring dissolving strip and method of use thereof which is relatively simple and economical in construction and is safe, efficient, and palatable in use.

### SUMMARY OF THE INVENTION

The present invention provides a method of flavoring a liquid comprising the steps of providing a generally inert base material which is soluble in at least some liquids of which one of the at least some liquids is water and further providing a flavoring material. A generally inert base material is then impregnated with the flavoring material to form a solid mixture of the generally inert base material and the flavoring material wherein the generally inert base material functions to carry the flavoring material and the solid mixture is then formed into at least two discrete solid dissolving units. The at least two discrete solid dissolving units are then stored in a dispensing container which is operative to permit dispensing of a selected one of the at least two discrete solid dissolving units while retaining the remaining ones of the at least two discrete solid dissolving units within the dispensing container. The dispensing container is then accessed to remove at least one of the at least two discrete solid dissolving units which is then placed in a liquid medium. The generally inert base material of the at least one of the at least two discrete solid dissolving units is then dissolved via the liquid medium to release the flavoring material into the liquid medium thereby flavoring the liquid medium via the flavoring material.

The present invention thus provides a liquid flavoring dissolving strip and method of use thereof which is not found in the prior art. For example, because the liquid flavoring dissolving strip comes in an easily dispensed and generally inert packaged form, it may be used in far more situations than those flavoring materials found in the prior art, and in fact may be carried with a person to flavor his or her water in a restaurant or bar situation. Furthermore, because the base material of which the present invention is constructed quickly and easily dissolves in many different types of liquid to release the citrus flavored material, it may be used not only with water, but also with such other beverages as iced tea, beer, or even mixed drinks to provide citrus flavoring where no citrus products are available. Finally, because the liquid flavoring dissolving strip and method of use thereof of the present invention includes no artificial or natural sweeteners, the addition of citrus flavoring to liquids is accomplished without adding other undesirable additives. It is therefore seen that the present invention provides a substantial improvement over the prior art.

### BRIEF DESCRIPTION OF THE DRAWINGS

FIG. 1 is a perspective view of the flavored strip of the present invention being inserted into an amount of liquid to flavor the liquid; and

FIG. 2 is a perspective view of one dispensing container for use with the present invention.

### DESCRIPTION OF THE PREFERRED EMBODIMENT

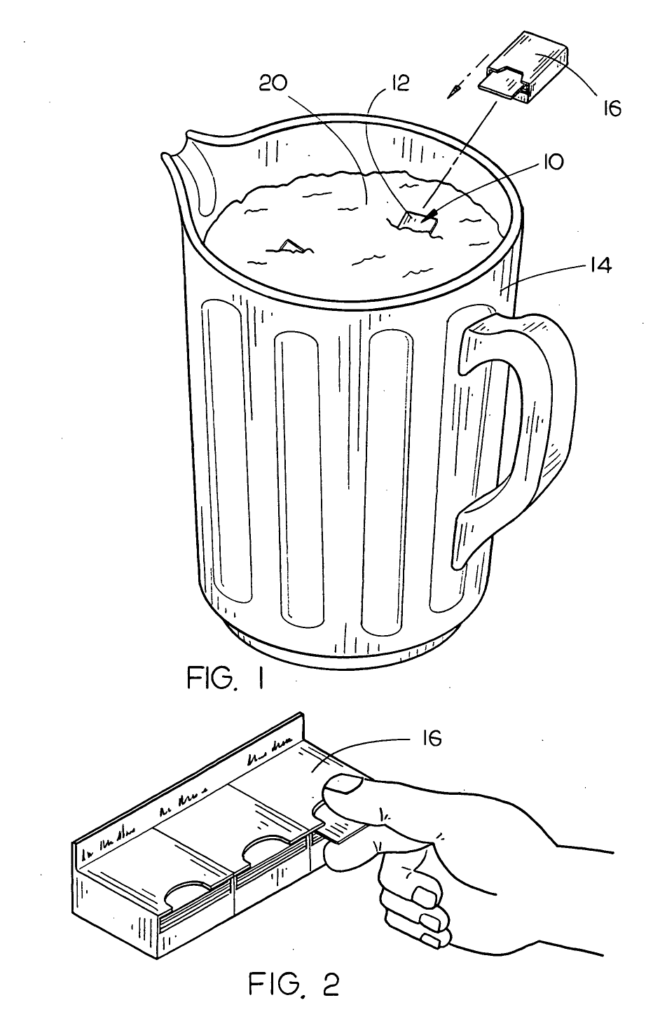

The liquid flavoring dissolving strips 10 of the present invention and method of using those strips are best shown in FIG. 1 as including a generally rectangular dissolving strip 12 of material which is impregnated with various flavorings. It is preferred that the dissolving strips 12 of the present invention be generally similar to the mint-flavored strips commonly marketed under the name Cool Mint Listerine PocketPaks strips, in that the base material for the dissolving strips 12 of the present invention is preferably a starch-based compound such as pullulan, which is an extra cellular bacterial polysaccharide produced from starch by a bacterium, specifically aureobasidium pullulans. The common method of manufacture of pullulan-based dissolving strips is to dissolve the processed pullulan, which is an odorless white-colored powder, in an amount of water, then spread the film solution onto a Teflon-coated glass plate and dry it for a period of time. The resulting thin dried film is then cut into generally rectangular strips which will dissolve in liquids. Various other additives may be included with the pullulan strips, such as jelling agents, including carrageenan, alginate, or agar, in addition to other preservatives and materials to increase the shelf life of the pullulan-based dissolving strip. Finally, flavoring materials may be added as per the desires of the manufacturer, with the most common being mint flavorings in the case of Listerine PocketPaks or other such breath-cleansing flavorings. In connection with the present invention, however, the preferred flavorings would be from the citrus group of flavorings, including lemon, lime, orange, and other such citrus flavorings. One or more of these flavorings would be added to the dissolved pullulan material to form a pullulan solution prior to casting the solution onto the plate for drying and, when the resulting dried pullulan solution film is cut into strips, each of the strips would thus be flavored with the citrus flavoring. The packaging 16 of the strips would then be completed in any appropriate form, such as that shown in FIG. 2, and the product is then ready for use in flavoring of liquids. The packaging 16, however, should be of a type which permits quick and simple dispensing of individual strips of the strips of the dried pullulan solution to facilitate the method of use of the present invention.

Of course, it is preferred that the intensity of the flavoring in each of the strips be substantially greater than that used in connection with breath freshening strips as the strip is intended to flavor a substantial amount of liquid. The level of intensity of the flavoring will generally be determined by the manufacturer and will depend on several factors such as the specific base material used for the dissolving strips 12, the amount of liquid the strip is intended to flavor and the specific flavoring used in the dissolving strips 12, but in virtually all instances, the flavoring intensity will be greater than that found in the standard breath freshening strips.

The method of use of the present invention is shown best in FIG. 1 and would involve the following steps. A user of the present invention would take one of the dissolving strips out of the packaging 16 and place the strip into the container 14 within which is the liquid 20 to be flavored. It is expected that the most common liquid to be flavored by the present invention would be water, as it has been found that the addition of citrus flavorings to water increases the palatability of the water and hence the enjoyment of drinking the water. Of course, it should be noted that the flavoring strips of the present invention may be added to any appropriate liquid, including sodas, mixed alcoholic drinks, and other such liquids wherein a citrus flavoring may be added. Once the dissolving strip 12 is placed within the liquid 20, the pullulan material forming the base material of the strip dissolves in the liquid 20, thus releasing the flavorings within the strip into the liquid 20. By merely stirring the liquid 20, the flavorings are then dispersed throughout the liquid 20 and the liquid 20 is consequently flavored by the dissolution of the strip 20. By placing additional strips in the liquid 20, or by increasing the concentration of flavoring within each strip, the intensity of the flavoring in the liquid 20 may be modified or changed depending on the desires of the user of the present invention.

It is to be understood that numerous additions, substitutions, and modifications may be made to the liquid flavoring dissolving strips and method of use therefor of the present invention which fall within the intended broad scope of the above description. For example, virtually any type of flavoring may be added to the flavoring strip 12 as per the desires of the user of the present invention. Furthermore, although the flavoring strip 12 of the present invention has been described as being a pullulan-based product, various other types of dissolving materials may be substituted so long as the intended functionality of the present invention is maintained. Finally, it should be noted that, although the present invention is primarily intended to flavor water-based liquids, virtually any type of liquid may be flavored by the present invention so long as the dissolving strip 12 dissolves within the liquid.

There has therefore been shown and described a liquid flavoring dissolving strip and method of use therefor which accomplishes at least all of its intended objectives.

1. A method of flavoring a liquid comprising the steps:.
providing a generally inert base material which is soluble in at least some liquids of which one of said at least some liquids is water;
providing a flavoring material;
impregnating said generally inert base material with said flavoring material to form a solid mixture of said generally inert base material and said flavoring material wherein said generally inert base material functions to carry said flavoring material;
forming said solid mixture into at least two discrete solid dissolving units;
storing said at least two discrete solid dissolving units in a dispensing container, said dispensing container operative to permit dispensing of a selected one of said at least two discrete solid dissolving units while retaining the remaining ones of said at least two discrete solid dissolving units within said dispensing container;
accessing said dispensing container to remove at least one of said at least two discrete solid dissolving units;
placing said at least one of said at least two discrete solid dissolving units in a liquid medium;
dissolving said generally inert base material of said at least one of said at least two discrete solid dissolving units via said liquid medium to release said flavoring material into said liquid medium thereby flavoring said liquid medium via said flavoring material.

2. The method of claim 1 wherein said step of providing a generally inert base material comprises providing an extra cellular bacterial polysaccharide produced from starch by a bacterium, specifically aureobasidium pullulans, hereinafter referred to as epullulan.

3. The method of claim 2 wherein said step of providing a flavoring material comprises providing a flavoring selected from the group consisting of lemon, lime, orange, and citrus.

4. The method of claim 2 wherein said step of forming said solid mixture into at least two discrete solid dissolving units comprises dissolving the processed pullulan in an amount of water, spreading pullulan solution onto a generally flat plate, drying said pullulan solution and cutting said dried pullulan solution into generally rectangular strips which will dissolve in liquids.

5. A method of flavoring a liquid comprising the steps:
providing an amount of pullulan, which is an extra cellular bacterial polysaccharide produced from starch by a bacterium, specifically aureobasidium pullulans, said amount of pullulan being soluble in water;
providing an amount of a flavoring material selected from the group consisting of lemon, lime, orange, and citrus;
mixing said amount of pullulan with said amount of flavoring material and an amount of water to form a pullulan solution;
spreading said pullulan solution over a generally flat plate;
drying said pullulan solution on said generally flat plate;
cutting said dried pullulan solution into at least two discrete solid dissolving units;
storing said at least two discrete solid dissolving units in a dispensing container, said dispensing container operative to permit dispensing of a selected one of said at least two discrete solid dissolving units while retaining the remaining ones of said at least two discrete solid dissolving units within said dispensing container;
accessing said dispensing container to remove at least one of said at least two discrete solid dissolving units;
placing said at least one of said at least two discrete solid dissolving units in a liquid medium;
dissolving said amount of pullulan of said at least one of said at least two discrete solid dissolving units via said liquid medium to release said flavoring material into said liquid medium thereby flavoring said liquid medium via said flavoring material.

6. A method of flavoring a liquid comprising the steps:
providing an amount of a base material which is soluble in water;
providing an amount of a flavoring material;
mixing said amount of a base material with said amount of flavoring material and an amount of water to form a solution;
spreading said solution over a generally flat plate;
drying said solution on said generally flat plate;
cutting said dried solution into at least two pieces;
storing said at least pieces in a dispensing container, said dispensing container operative to permit dispensing of a selected one of said at least two pieces while retaining the remaining ones of said at least two pieces within said dispensing container;
accessing said dispensing container to remove at least one of said at least two pieces;
placing said at least one of said at least two pieces in a liquid medium;
dissolving said amount of a base material of said at least one of said at least two pieces via said liquid medium to release said flavoring material into said liquid medium thereby flavoring said liquid medium via said flavoring material.

7. The method of claim 6 wherein said step of providing an amount of a base material comprises providing an amount of an extra cellular bacterial polysaccharide produced from starch by a bacterium, specifically aureobasidium pullulans, hereinafter referred to as pullulan.

8. The method of claim 7 wherein said step of providing a flavoring material comprises providing a flavoring selected from the group consisting of lemon, lime, orange, and citrus.
